(19) United States
(12) Patent Application Publication
(10) Pub. No.: US 2025/0245393 A1
(43) Pub. Date: Jul. 31, 2025

(54) MODULAR KITCHEN FURNITURE KIT FOR SELECTIVE ASSEMBLY AND ONLINE SIMULATION SYSTEM FOR SELECTION AND ASSEMBLY OF MODULAR KITCHEN FURNITURE

(71) Applicant: Yi-Hsin LIN, Düsseldorf (DE)

(72) Inventor: Yi-Hsin LIN, Düsseldorf (DE)

(21) Appl. No.: 19/037,092

(22) Filed: Jan. 25, 2025

Related U.S. Application Data
(60) Provisional application No. 63/624,941, filed on Jan. 25, 2024.

(51) Int. Cl. G06F 30/13; G06F 111/16; G06Q 30/0601

(52) U.S. Cl. CPC G06F 30/13; G06Q 30/0621; G06F 2111/16

(57) ABSTRACT

A modular kitchen system furniture kit for selective assembly including a plurality of storage-type kitchen furniture units, a plurality of appliance-type kitchen furniture units and a plurality of sink-type modular kitchen furniture units. The width, the height and the depth of each of the storage-type kitchen furniture units and the appliance-type kitchen furniture units are integer multiples of the unit width, the unit height and the unit depth, respectively. The width and the depth of each of the sink-type modular kitchen furniture units are integer multiples of the unit width and the unit depth, respectively. Through an online simulation system for selection and assembly of modular kitchen system furniture, one may select at least two from the storage-type kitchen furniture units, the appliance-type kitchen furniture units, and the sink-type modular kitchen furniture units to assemble a modular kitchen system furniture.

### CROSS-REFERENCE TO RELATED APPLICATION

This application claims the priority benefit of U.S. Provisional Application Ser. No. 63/624,941, filed on Jan. 25, 2024. The entirety of the above-mentioned patent application is hereby incorporated by reference herein and made a part of the specification.

### BACKGROUND OF THE INVENTION

### Field of the Invention

The present invention generally relates to a system furniture kit and an online simulation system for selection and assembly and, more particularly, to a modular kitchen system furniture kit for selective assembly and an online simulation system for selection and assembly of modular kitchen system furniture.

### Description of the Related Art

Generally, existing furniture manufacturers often provide consumers with more convenient furniture by integrating various types of furniture into system furniture. Although such system furniture offers multiple functionalities, its dimensions and functionalities are often constrained, making it difficult for users to select the most suitable type from various system furniture options and preventing users from selecting their ideal furniture combinations.

### BRIEF SUMMARY OF THE INVENTION

In view of the above, system furniture is typically designed by professionals based on the needs of the majority, thus having limitations in dimensions and functionalities. Consequently, users may only select the closest match from existing designs and make limited personal adjustments, rather than allowing users to create combinations based on their requirements. This is highly inconvenient. Therefore, one object of the present invention is to provide a modular kitchen system furniture kit for selective assembly and an online simulation system for selection and assembly of modular kitchen system furniture, enabling users to freely customize the most suitable personalized system furniture according to their needs.

To address the foregoing issues, the present invention provides a modular kitchen system furniture kit for selective assembly, manufactured according to a unit width, a unit height, and a unit depth, and the modular kitchen system furniture kit for selective assembly includes a plurality of storage-type kitchen furniture units, a plurality of appliance-type kitchen furniture units, and a plurality of sink-type modular kitchen furniture units.

Each of the storage-type kitchen furniture units has at least one storage space, and has a first width, a first height, and a first depth, wherein the first width, the first height and the first depth are integer multiples of the unit width, the unit height and the unit depth, respectively.

Each of the appliance-type kitchen furniture units is equipped with at least one kitchen appliance and has a second width, a second height and a second depth, wherein the second width, the second height and the second depth are integer multiples of the unit width, the unit height and the unit depth, respectively.

Each of the sink-type modular kitchen furniture units is provided with a sink or a sink drainpipe and has a third width and a third depth, wherein the third width and the third depth are integer multiples of the unit width and the unit depth, respectively.

At least two of the storage-type kitchen furniture units, the appliance-type kitchen furniture units, and the sink-type modular kitchen furniture units are selected as at least two selected furniture units to assemble a modular kitchen system furniture.

In one embodiment, the modular kitchen system furniture kit for selective assembly further includes a plurality of cross-linking frame and a plurality of end supporting frames, wherein at least two of the cross-linking frames and the end supporting frames are configured to be assembled onto the modular kitchen system furniture to adjust an elevated height of the modular kitchen system furniture, and each of the cross-linking frames and each of the end supporting frames have a joining length, which is an integer multiple of the unit depth.

Preferably, each of the cross-linking frames and each of the end supporting frames further include a frame base and a pillar body, the frame base is configured to be assembled onto the modular kitchen system furniture and includes a pillar connection slot, and the pillar body is telescopically inserted and fixed into the pillar connection slot.

In one embodiment, the modular kitchen system furniture kit for selective assembly further includes a plurality of top boards, each having a fourth width and a fourth depth, wherein the fourth width and the fourth depth are integer multiples of the unit width and the unit depth, respectively, and at least one of the top boards is configured to cover a top portion of the modular kitchen system furniture except for the sink-type modular kitchen furniture units.

In one embodiment, a top portion of each of the storage-type kitchen furniture units and each of the appliance-type kitchen furniture units includes at least one first positioning structure, and a bottom portion of each of the storage-type kitchen furniture units and each of the appliance-type kitchen furniture units includes at least one second positioning structure, such that during assembly, the at least one first positioning structure and the at least one second positioning structure that are vertically adjacent engage for alignment with each other.

Preferably, the modular kitchen system furniture kit for selective assembly further includes a plurality of cross-linking frame and a plurality of end supporting frames, wherein each of the cross-linking frames and each of the end supporting frames have a joining length, which is an integer multiple of the unit depth, and a top portion of each of the cross-linking frames and a top portion of each of the cross-linking frames and each of the end supporting frames includes at least one first positioning structure, wherein one of the cross-linking frames is configured to connect at least two selected furniture units that are adjacent along a furniture width direction, and two of the end supporting frame are configured to fixedly connect to two opposite ends of the modular kitchen system furniture.

The sink-type modular kitchen furniture units include at least one sink unit and at least one sink cabinet unit, wherein the at least one sink unit is equipped with the sink, the at least one sink cabinet unit is equipped with the sink drainage pipe, the at least one sink unit and the at least one sink cabinet unit are configured to assemble a sink-type modular kitchen furniture unit, and a bottom portion of each of the sink-type kitchen furniture units includes at least one second positioning structure.

Moreover, each of the first positioning structures and each of the second positioning structures are manually rotated and locked using a knob-type bolt.

In one embodiment, the storage-type kitchen furniture units include a single-tier drawer storage cabinet unit, a double-tier drawer storage cabinet unit, or an open storage cabinet unit.

In one embodiment, the appliance-type kitchen furniture units include a dishwasher furniture unit, a refrigerator furniture unit, an oven furniture unit, or an oven-and-induction-cooker combination furniture unit.

In one embodiment, the modular kitchen system furniture is an island-style kitchen system furniture or a wall-mounted kitchen system furniture.

In one embodiment, each of the storage-type kitchen furniture units, each of the appliance-type kitchen furniture units, and each of the sink-type modular kitchen furniture units comprise magnets embedded in a side wall thereof to enable mutual magnetic fixation during assembly.

In another aspect, the present invention provides an online simulation system for selection and assembly of modular kitchen system furniture having a unit width, a unit height, and a unit depth. The online simulation system includes a data storage module and a processing module.

The data storage module corresponds to a plurality of storage-type kitchen furniture units, a plurality of appliance-type kitchen furniture units, a plurality of sink-type modular kitchen furniture units, and a plurality of length direction frames, respectively, and stores a plurality of storage-type kitchen furniture unit data, a plurality of appliance-type kitchen furniture unit data, a plurality of sink-type modular kitchen furniture unit data, and a plurality of length direction frame data, respectively. Each of the storage-type kitchen furniture unit data includes a 3D storage-type kitchen furniture unit modeling image, a first width, a first height, and a first depth, each of the appliance-type kitchen furniture unit data includes a 3D appliance-type kitchen furniture unit modeling image, a second width, a second height, and a second depth, each of the sink-type modular kitchen furniture unit data includes a 3D sink-type modular kitchen furniture unit modeling image, a third width, and a third depth, and each of the length direction frame data includes a 3D frame modeling image and a joining length.

The processing module is communicatively connected to the data storage module, provided with an application installed therein, and connected to an application webpage after executing the application. The application webpage includes a furniture selection interface unit, a furniture data retrieval unit, a furniture unit image splicing unit and an accessory image splicing unit.

The furniture selection interface unit is configured to retrieve the storage-type kitchen furniture unit data, the appliance-type kitchen furniture unit data, the sink-type modular kitchen furniture unit data, and the length direction frame data to allow a user to select at least two from the storage-type kitchen furniture units, the appliance-type kitchen furniture units, and the sink-type modular kitchen furniture units as at least two selected furniture units.

The furniture data retrieval unit is configured to retrieve at least two from the 3D storage-type kitchen furniture unit modeling image, the 3D appliance-type kitchen furniture unit modeling image, and the 3D sink-type modular kitchen furniture unit modeling image as at least two selected 3D furniture unit modeling images according to the at least two selected furniture units.

The furniture unit image splicing unit is configured to be operated by the user to splice the at least two selected 3D furniture unit modeling images into a 3D kitchen system furniture body modeling image.

The accessory image splicing unit is configured to be operated by the user to splice at least one 3D frame modeling image to the 3D kitchen system furniture body modeling image to form a 3D modular kitchen system furniture modeling image, thereby enabling online simulation of selection and assembly of the modular kitchen system furniture.

More particularly, the first width, the second width, the third width and the joining length are integer multiples of the unit width; the first height, the second height are integer multiples of the unit height, and the first depth, the second depth, the third depth and the fourth depth are integer multiples of the unit depth.

In another aspect, the data storage module further stores a plurality of top board data, and each of the top board data includes a 3D top board modeling image, a fourth width, and a fourth depth.

As mentioned above, compared to prior art system furniture which mostly consists of pre-integrated templates, forcing users to select from existing furniture combinations rather than creating ideal system furniture based on actual needs, the present invention mainly manufactures multiple storage-type kitchen furniture units, multiple appliance-type kitchen furniture units and multiple sink-type modular kitchen furniture units according to a unit width, a unit height and a unit depth. Therefore, when users select the needed furniture kits, they may use furniture kits with proportional relationships in width and depth to make corresponding connections, thereby combining into a modular kitchen system furniture that best satisfies user requirements.

The specific embodiments adopted by the present invention will be further described with the following examples and figures.

### BRIEF DESCRIPTION OF THE DRAWINGS

FIG. 1 is a perspective view of a modular kitchen system furniture kit for selective assembly according to the present invention;

FIG. 2 is a perspective view of a modular kitchen system furniture assembled using a modular kitchen system furniture kit for selective assembly according to the present invention;

FIG. 3 is an exploded perspective view of a modular kitchen system furniture assembled using a modular kitchen system furniture kit for selective assembly according to the present invention;

FIG. 4 is an exploded perspective view of a sink-type modular kitchen furniture units being assembled with a cross-linking frame and an end supporting frame;

FIG. 5 is an exploded perspective view of a sink-type modular kitchen furniture units being assembled with another sink-type modular kitchen furniture unit;

FIG. 6 is an exploded perspective view of a storage-type kitchen furniture units being assembled with two cross-linking frames and adjacent to a sink-type modular kitchen furniture unit;

FIG. 7 is a cross-sectional view along line A-A of FIG. 4;

FIG. 8 is a cross-sectional view along line B-B of FIG. 7;

FIG. 9 shows a system block diagram of an online simulation system for selection and assembly of modular kitchen system furniture according to the present invention; and

FIG. 10 to FIG. 14 are schematic diagrams of corresponding screens illustrating a 3D furniture combination simulation webpage generated based on user operations by an online simulation system for selection and assembly of modular kitchen system furniture according to the present invention.

### DETAILED DESCRIPTION OF THE EMBODIMENTS

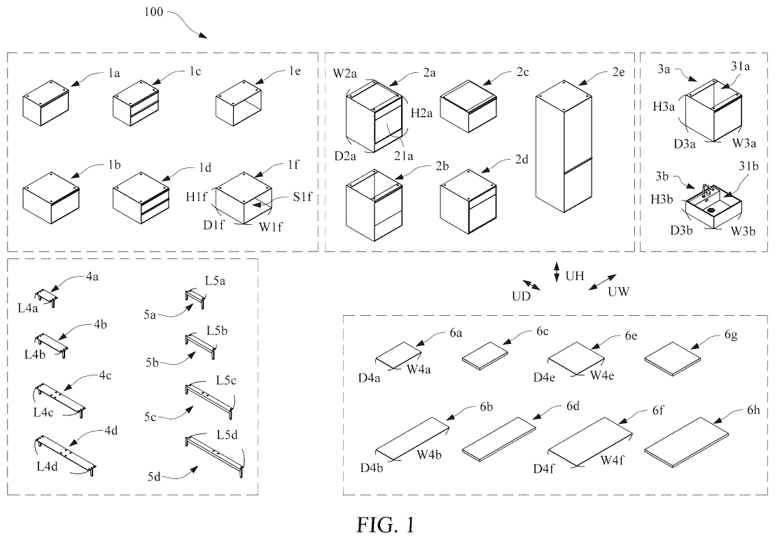

Please refer to FIG. 1, which shows a perspective view of a modular kitchen system furniture kit for selective assembly according to the present invention. As shown in FIG. 1, modular kitchen system furniture kit for selective assembly 100 includes six storage-type kitchen furniture units 1a-1f, five appliance-type kitchen furniture units 2a-2e, two sink-type modular kitchen furniture units 3a and 3b, four cross-linking frames 4a-4d, four end supporting frames 5a-5d, and eight top boards 6a-6h. Each of the above components is manufactured according to a unit width UW, a unit height UH, and a unit depth UD, and in this embodiment, the unit width UW is, for example, 76 CM, the unit height UH is, for example, 76 CM, and the unit depth UD is, for example, 38 CM.

Taking the storage-type kitchen furniture unit 1f as an example, it has a storage space S1f, and has a first width W1f, a first height H1f, and a first depth D1f, which are respectively one time the unit width UW, one time the unit height UH, and two times the unit depth UD in this embodiment, but the present invention is not limited to this. In other embodiments, the first width W1f, the first height H1f, and the first depth D1f may also be other integer multiples of the unit width UW, the unit height UH, and the unit depth UD respectively.

Similarly, each of the other storage-type kitchen furniture units 1a-1e has a storage space (not shown), and respectively has a first width (not shown), a first height (not shown), and a first depth (not shown). The first width, the first height, and the first depth of each of these storage-type kitchen furniture units 1a-1e are also integer multiples of the unit width UW, the unit height UH, and the unit depth UD respectively. Furthermore, the first width and the first height of each of the storage-type kitchen furniture units 1a-1e are one time the unit width UW and one time the unit height UH respectively, the first depths of the storage-type kitchen furniture units 1a, 1c, and 1e are all one time the unit depth UD, and the first depths of storage-type kitchen furniture units 1b and 1d are both two times the unit depth UD.

As mentioned above, in this embodiment, the storage-type kitchen furniture units 1a and 1b are single-tier drawer storage cabinet units, the storage-type kitchen furniture units 1c and 1d are double-tier drawer storage cabinet units, and the storage-type kitchen furniture units 1 and 1f are open storage cabinet units.

Taking the appliance-type kitchen furniture unit 2a as an example, it is equipped with a kitchen appliance 21a and has a second width W2a, a second height H2a, and a second depth D2a. In this embodiment, the second width W2a and the second depth D2a are respectively one time the unit width UW and two times the unit depth UD, but the present invention is not limited to this. In other embodiments, the second width W2a and the second depth D2a may also be other integer multiples of the unit width UW and the unit depth UD respectively. Furthermore, in this embodiment, the second height H2a is two times the unit height UH, but the present invention is not limited to this. In practice, the second height H2a approaches an integer multiple of the unit height UH.

Similarly, each of the other appliance-type kitchen furniture units 2b-2e has a kitchen appliance (not shown), and has a second width (not shown), a second height (not shown), and a second depth (not shown). The second width and the second depth of each of these appliance-type kitchen furniture units 2b-2e are also integer multiples of the unit width UW and the unit depth UD respectively, and the second height H2a of each of these appliance-type kitchen furniture units 2b-2e approaches an integer multiple of the unit height UH. Furthermore, the second width and the second depth of each of the appliance-type kitchen furniture units 2b-2e are one time the unit width UW and one time the unit depth UD, respectively.

Moreover, in this embodiment, the appliance-type kitchen furniture unit 2a is, for example, an oven-and-induction-cooker combination furniture unit, the appliance-type kitchen furniture unit 2b is, for example, a dishwasher furniture unit, the appliance-type kitchen furniture unit 2c is, for example, an induction cooker furniture unit, the appliance-type kitchen furniture unit 2d is, for example, an oven furniture unit, and the appliance-type kitchen furniture unit 2e is, for example, a refrigerator furniture unit.

The sink-type modular kitchen furniture unit 3a has a plumbing installation space 31a, and the sink-type modular kitchen furniture unit 3b has a sink 31b. Taking the sink-type modular kitchen furniture unit 3a as an example, the sink-type modular kitchen furniture unit 3a also has a third width W3a, a third height H3a, and a third depth D3a. The third width W3a is one time the unit width UW, while the third depth D3a is two times the unit depth UD, but the present invention is not limited to this. In other embodiments, the third width W3a and the third depth D3a may also be other integer multiples of the unit width UW and the unit depth UD. The sink-type modular kitchen furniture unit 3b also features a third width W3b, a third height H3b, and a third depth D3b, where the third width W3b is one time the unit width UW and the third depth D3b is two times the unit depth UD. Furthermore, the combined third height H3a and H3b approaches two times the unit height UH.

The cross-linking frames 4a-4d have a joining length L4a-L4d, respectively, and the joining lengths L4a-L4d are respectively one to four times the unit depth UD, but the present invention is not limited to this. In other embodiments, the joining lengths L4a-L4d may also be other integer multiples of the unit depth UD.

The end supporting frames 5a-5d have a joining length L5a-L5d, respectively, and the joining lengths L5a-L5d are respectively one to four times the unit depth UD, but the present invention is not limited to this. In other embodiments, the joining lengths L5a-L5d may also be other integer multiples of the unit depth UD.

It should be specifically noted that in this embodiment, the cross-linking frame 4a and the end supporting frame 5a are configured to assemble a furniture unit with one time the unit depth UD, the cross-linking frame 4b and the end supporting frame 5b are configured to assemble a furniture unit with two times unit the depth UD, while the cross-linking frame 4c and the end supporting frame 5c are configured to assemble a furniture unit with one time the unit depth UD and a furniture unit of two times the unit depth UD, meaning that they are configured for island-style double-sided arrangement with different depths on both sides. In contrast, the cross-linking frame 4d and the end supporting frame 5d are also configured for island-style double-sided arrangement, but with both sides designed for assembling furniture units of two times the unit depth UD.

Taking top boards 6a, 6b, 6e, and 6f as examples, the top board 6a has a fourth width W4a and a fourth depth D4a, the top board 6b has a fourth width W4b and a fourth depth D4b, the top board 6e has a fourth width W4e and a fourth depth D4e, the top board 6f has a fourth width W4f and a fourth depth D4f.

In this embodiment, the fourth widths W4a and W4e are both one time the unit width UW, while the fourth widths W4b and W4f are both two times the unit width UW. The fourth depths D4a and D4b are both one time the unit depth UD, while the fourth depths D4e and D4f are both two times the unit depth UD. Furthermore, the depth and the width of the top board 6c are the same as those of the top board 6a, but the only difference is that the height (i.e., the thickness) of the top board 6c is greater than that of the top board 6a. Similarly, the top board 6d has the same depth and width as the top board 6b, but a greater height than the top board 6b. Likewise, the top boards 6g and 6h have the same depths and widths as the top board 6e and 6f respectively, but their heights are greater than those of the top board 6e and 6f respectively.

More particularly, the material of the top boards 6a, 6b, 6e, and 6f is, for example, stainless steel, while the material of the top boards 6c, 6d, 6g, and 6h is, for example, oak. Furthermore, in practical applications, the top boards 6a-6h are configured to cover parts except for the sink-type modular kitchen furniture unit 3a and the appliance-type kitchen furniture unit 2c. For example, they are configured to cover the storage-type kitchen furniture units 1a, 1b, 1c, 1d, 1e, 1f, the appliance-type kitchen furniture units 2a, 2b, 2d, or 2e.

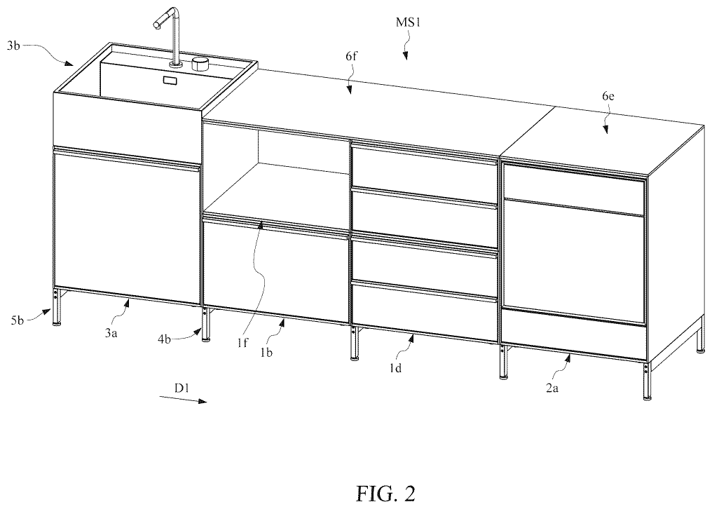

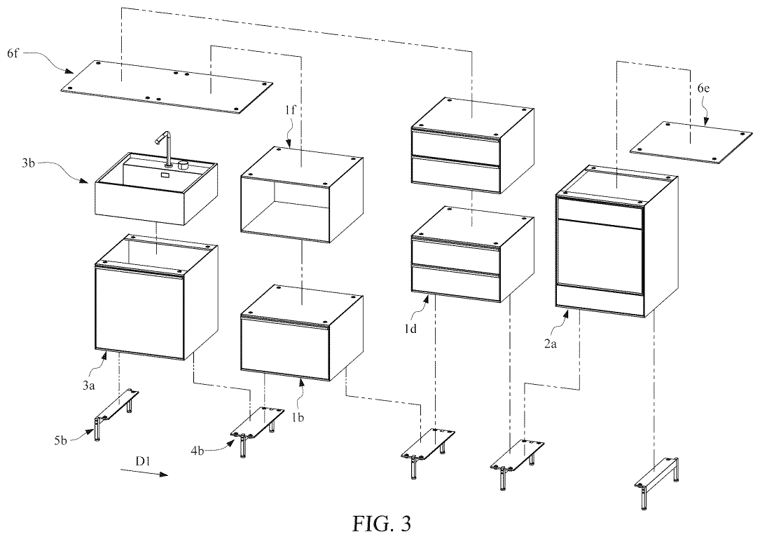

Please proceed to FIG. 2 and FIG. 3 for reference, where FIG. 2 is a perspective view of a modular kitchen system furniture assembled using a modular kitchen system furniture kit for selective assembly according to the present invention, and FIG. 3 is an exploded perspective view of a modular kitchen system furniture assembled using a modular kitchen system furniture kit for selective assembly according to the present invention.

As shown in FIG. 1 to FIG. 3, taking a modular kitchen system furniture MS1 as an example, when a user selects one storage-type kitchen furniture unit 1b, two storage-type kitchen furniture units 1d, one storage-type kitchen furniture unit 1f, one appliance-type kitchen furniture unit 2a, one sink-type modular kitchen furniture unit 3a, one sink-type modular kitchen furniture unit 3b, one top board 6f, and one top board 6e as selected furniture units from the aforementioned modular kitchen system furniture kit for selective assembly 100, these furniture units may be assembled into a modular kitchen system furniture MS1. Furthermore, the user may select three cross-linking frames 4b and two end supporting frames 5b from the aforementioned modular kitchen system furniture kit for selective assembly 100 to be installed at a bottom portion of the modular kitchen system furniture MS1, thereby elevating the modular kitchen system furniture MS1. In this embodiment, the modular kitchen system furniture MS1 is a wall-mounted kitchen system furniture, but the present invention is not limited to this. In other embodiments, it may also be an island-style kitchen system furniture.

As stated above, in this embodiment, the three cross-linking frames 4b are arranged along a furniture width direction D1 to connect two adjacent selected furniture units, while the two end supporting frames 5b are connected at the two opposite ends of the modular kitchen system furniture MS1.

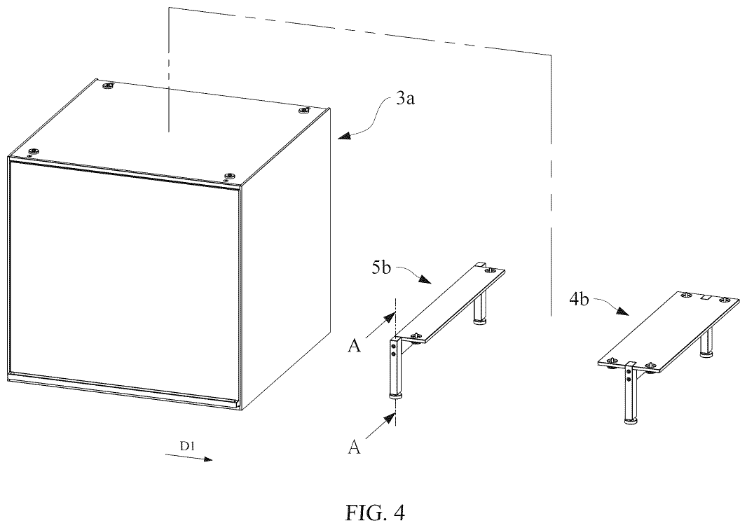

Please proceed to FIG. 4 for reference, where FIG. 4 is an exploded perspective view of a sink-type modular kitchen furniture units being assembled with a cross-linking frame and an end supporting frame.

As shown in FIG. 1 to FIG. 4, when assembling the aforementioned modular storage system furniture MS1, for example, one may first connect the two ends of a bottom portion of a sink-type modular kitchen furniture unit 3a to the cross-linking frames 4b and the end supporting frames 5b respectively.

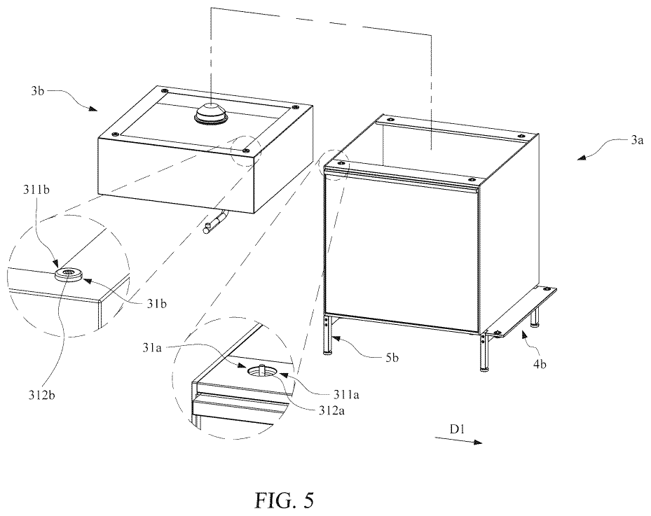

Please proceed to FIG. 5 for reference, where FIG. 5 is an exploded perspective view of a sink-type modular kitchen furniture units being assembled with another sink-type modular kitchen furniture unit. As shown in FIG. 1 to FIG. 5, after the sink-type modular kitchen furniture unit 3a is connected to the cross-linking frames 4b and the end supporting frames 5b, the sink-type modular kitchen furniture unit 3b may be further assembled to the sink-type modular kitchen furniture unit 3a, thereby forming a sink-type kitchen furniture unit (not shown).

As stated above, in this embodiment, the sink-type modular kitchen furniture unit 3a has first positioning structures 31a at four corner ends of its top portion, and the sink-type modular kitchen furniture unit 3b has second positioning structure 31b at four corner ends of its bottom portion, wherein the four first positioning structures 31a correspond respectively to the four second positioning structures 31b, thereby allowing the sink-type modular kitchen furniture unit 3b to be fixed to the sink-type modular kitchen furniture unit 3a through the connection of the first positioning structures 31a and the second positioning structures 31b.

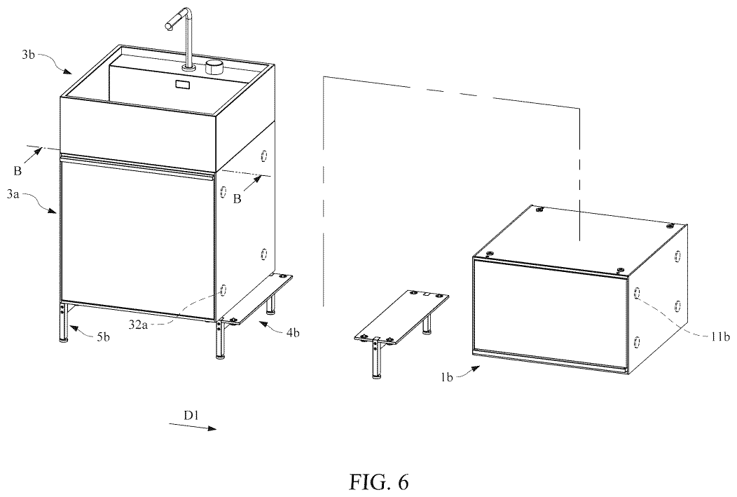

Please proceed to FIG. 6 for reference, where FIG. 6 is an exploded perspective view of a storage-type kitchen furniture units being assembled with two cross-linking frames and adjacent to a sink-type modular kitchen furniture unit. As shown in FIG. 1 to FIG. 6, after the sink-type modular kitchen furniture unit 3a is assembled to the cross-linking frames 4b and the end supporting frames 5b, the user may connect the storage-type kitchen furniture unit 1b to two cross-linking frames 4b, positioning the storage-type kitchen furniture unit 1b adjacent to the sink-type modular kitchen furniture unit 3a. The storage-type kitchen furniture unit 1b further includes four magnetic elements 11b (only one is shown in the figure), which are embedded at four corners of the side walls of the storage-type kitchen furniture unit 1b. Similarly, four magnetic elements 32a (only one is shown in the figure) are also embedded in the side walls of the sink-type modular kitchen furniture unit 3a. Therefore, when the storage-type kitchen furniture unit 1b is adjacent to the sink-type modular kitchen furniture unit 3a, they may be temporarily positioned through mutual magnetic attraction of the magnetic elements 32a and 11b, facilitating convenient assembly for the user.

Furthermore, in actual operation, the user may first lock one cross-linking frame 4b to one end of the bottom portion of the storage-type kitchen furniture unit 1b, then place the other end of the storage-type kitchen furniture unit 1b on the cross-linking frame 4b that has already been fixed to the sink-type modular kitchen furniture unit 3a, and subsequently secure them through the connection of the first positioning structure (not shown, equivalent to the aforementioned first positioning structure 31a) and the second positioning structure (not shown, equivalent to the aforementioned second positioning structure 31b).

As stated above, since the cross-linking frames 4b, the end supporting frames 5b, the storage-type kitchen furniture units 1b, 1d and 1f, the appliance-type kitchen furniture unit 2a, and the sink-type modular kitchen furniture units 3a all have first positioning structure (equivalent to the aforementioned first positioning structure 31a) at the top portions, and the storage-type kitchen furniture units 1b, 1d and 1f, the appliance-type kitchen furniture unit 2a, the sink-type modular kitchen furniture units 3a and 3b, and the top boards 6e and 6f all have second positioning structures (equivalent to the aforementioned second positioning structure 31b) at the bottom portions, therefore the components constituting the modular kitchen system furniture MS1 may be assembled according to the aforementioned connection method, allowing the first positioning structure and the second positioning structure that are vertically adjacent to engage with each other, thereby assembling the modular kitchen system furniture MS1 sequentially from bottom to top.

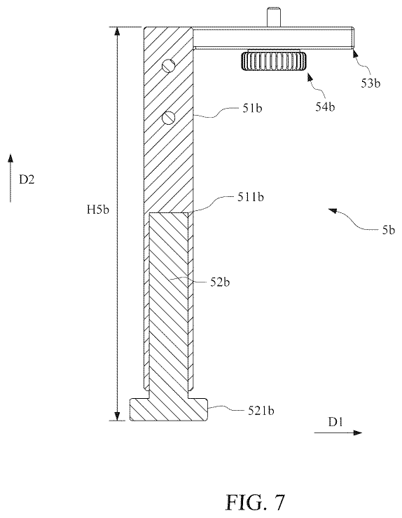

Please proceed to FIG. 7 for reference, where FIG. 7 is a cross-sectional view along line A-A of FIG. 4. As shown in FIG. 4 and FIG. 7, taking the end supporting frame 5b as an example, the end supporting frame 5b includes two frame bases 51b (only one is shown), two pillar bodies 52b (only one is shown), one supporting plate 53b, and one first positioning structure 31a. The frame base 51b extends along a vertical direction D2 perpendicular to the furniture width direction D1, and is provided with a pillar connection slot 511b vertically opened from the bottom surface along the vertical direction D2. The pillar body 52b is telescopically inserted and fixed in the pillar connection slot 511b along the vertical direction D2, while the supporting plate 53b is fixed to two frame bases 51b and extends along the furniture width direction D1. The first positioning structure 54b is installed on the supporting plate 53b.

More particularly, the end supporting frame 5b has an elevated height H5b, which may be adjusted through the telescopic movement of the pillar body 52b relative to the frame base 51b. For example, when the pillar body 52b is completely retracted into the frame base 51b as shown in FIG. 7, the elevated height H5b of the entire end supporting frame 5b is, for example, 10 centimeters. When the pillar body 52b is pulled out to its maximum length, the entire end supporting frame 5b may reach, for example, 15 centimeters, but the present invention is not limited to this. In practical application, the elevated height H5b of the entire end supporting frame 5b may also be adjusted only within a range as small as 1.5 centimeters. Furthermore, the adjustment of the height of the end supporting frame 5b may be achieved by, for example, providing internal threads inside the pillar connection slot 511b and external threads on the surface of the pillar body 52b, thereby adjusting the elevated height H5b of the end supporting frame 5b through the threaded depth of the pillar body 52b and the pillar connection slot 511b. In practice, this adjustment may be made, for instance, by manually rotating the pillar body 52b to control the depth of engagement between the threads. However, the present invention is not limited to this. Similarly, other cross-linking frame 4a-4d and end supporting frames 5a and 5c-5d may also adjust their overall elevated height (not shown) in this manner.

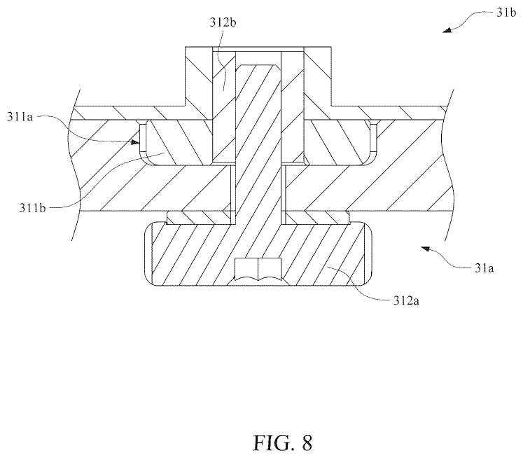

Please proceed to FIG. 8 for reference, where FIG. 8 is a cross-sectional view along line B-B of FIG. 7. As shown in FIG. 5 and FIG. 8, the first positioning structure 31a in this embodiment includes an engagement hole 311a and a rotary bolt312a, while the second positioning structure 31b includes a protrusion 311b and a stud structure 312b. The stud structure 312b is fixed inside the protrusion311b and has a threaded hole. Therefore, during actual assembly, the protrusion 311b may first be inserted into the engagement hole 311a for positioning, then the rotary bolt 312a may be inserted through one side of the engagement hole 311a and threaded into the threaded hole of the stud structure 312b, thereby securely connecting the two structures together.

It is worth noting that when the aforementioned sink-type modular kitchen furniture units 3a are assembled onto the cross-linking frame 4b and the end supporting frame 5b, the same structures as the aforementioned first positioning structure 31a and second positioning structure 31b are utilized for assembly.

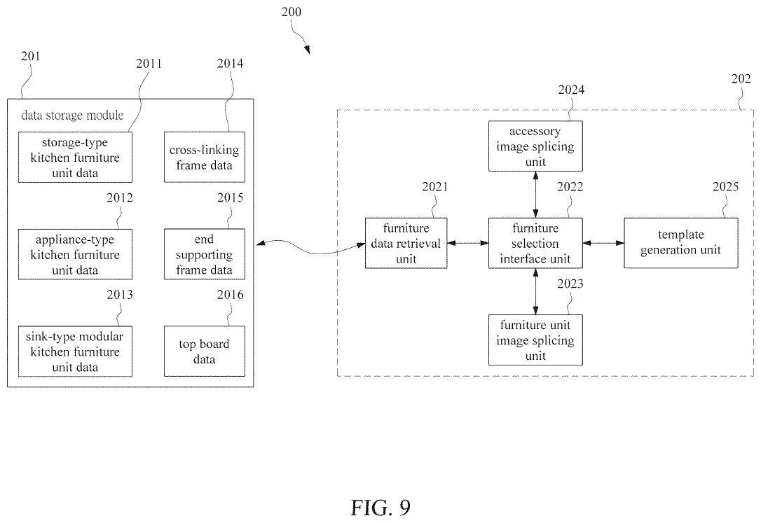

Please proceed to FIG. 9 for reference, where FIG. 9 is a system block diagram of an online simulation system for selection and assembly of modular kitchen system furniture according to the present invention. As shown in FIG. 9, an online simulation system for selection and assembly of modular kitchen system furniture 200 includes a data storage module 201 and a processing module 202. The online simulation system for selection and assembly of modular kitchen system furniture 200 has the aforementioned unit width UW, unit height UH, and unit depth UD.

The data storage module 201 corresponds to a plurality of storage-type kitchen furniture units 1a-1f, a plurality of appliance-type kitchen furniture units 2a-2e, a plurality of sink-type modular kitchen furniture units 3a-3b, a plurality of cross-linking frames 4a-4d, a plurality of end supporting frames 5a-5d, and a plurality of top boards 6a-6h, respectively, and stores a plurality of storage-type kitchen furniture unit data 2011 (only one is shown), a plurality of appliance-type kitchen furniture unit data 2012 (only one is shown), a plurality of sink-type modular kitchen furniture unit data 2013 (only one is shown), a plurality of cross-linking frame kitchen furniture unit data 2014 (only one is shown), a plurality of end supporting frames kitchen furniture unit data2015 (only one is shown), and a plurality of top board data 2016 (only one is shown), respectively.

Each of the storage-type kitchen furniture unit data 2011 includes a 3D storage-type kitchen furniture unit modeling image (not shown), which is established according to the first width, the first height, and the first depth of the corresponding storage-type kitchen furniture unit of the storage-type kitchen furniture unit data 2011. For example, when the storage-type kitchen furniture unit data 2011 corresponds to the aforementioned storage-type kitchen furniture unit 1f, its 3D storage-type kitchen furniture unit modeling image is established according to the first width W1f, the first height H1f, and the first depth D1f.

Each of the appliance-type kitchen furniture unit data 2012 includes a 3D appliance-type kitchen furniture unit modeling image (not shown), which is established according to the second width, the second height, and the second depth of the corresponding appliance-type kitchen furniture unit of the appliance-type kitchen furniture unit data 2012. For example, when the appliance-type kitchen furniture unit data 2012 corresponds to the aforementioned appliance-type kitchen furniture unit 2a, its 3D appliance-type kitchen furniture unit modeling image is established according to the second width W2a, the second height H2a, and the second depth D2a.

Each of the sink-type modular kitchen furniture unit data 2013 includes a 3D sink-type modular kitchen furniture unit modeling image (not shown), which is established according to the third width, the third height, and the third depth of the corresponding sink-type modular kitchen furniture unit of the sink-type modular kitchen furniture unit data 2013. For example, when the sink-type modular kitchen furniture unit data 2013 corresponds to the aforementioned sink-type modular kitchen furniture unit 3a, its 3D sink-type modular kitchen furniture unit modeling image is established according to the third width W3a, the third height H3a, and the third depth D3a.

Each of the cross-linking frame kitchen furniture unit data 2014 includes a 3D cross-linking frame modeling image (not shown), which is established according to the joining length of the corresponding cross-linking frame unit of the cross-linking frame kitchen furniture unit data 2014. For example, when the cross-linking frame kitchen furniture unit data 2014 corresponds to the aforementioned cross-linking frame4a, its 3D cross-linking frame modeling image is established according to the joining length L4a.

Each of the end supporting frame kitchen furniture unit data 2015 includes a 3D end supporting frame modeling image (not shown), which is established according to the joining length of the corresponding end supporting frame unit of the end supporting frame kitchen furniture unit data 2015. For example, when the end supporting frame kitchen furniture unit data 2015 corresponds to the aforementioned end supporting frame 5a, its 3D end supporting frame modeling image is established according to the joining length L5a.

Each of the top board data 2016 includes a 3D top board modeling image (not shown), which is established according to the fourth width and the fourth depth of the corresponding top board of the top board data 2016. For example, when the top board data 2016 corresponds to the aforementioned top board 6a, its 3D top board modeling image is established according to the fourth width W6a and the fourth depth D6a.

The processing module 202 includes a furniture data retrieval unit 2021, a furniture selection interface unit2022, a furniture unit image splicing unit 2023, an accessory image splicing unit 2024, and a template generation unit 2025.

The furniture data retrieval unit 2021 is communicatively connected to the data storage module 201, and is configured to retrieve the storage-type kitchen furniture unit data 2011, the appliance-type kitchen furniture unit data 2012, the sink-type modular kitchen furniture unit data 2013, cross-linking frame kitchen furniture unit data 2014, the end supporting frame kitchen furniture unit data 2015, the end supporting frame kitchen furniture unit data 2015, and the top board data 2016.

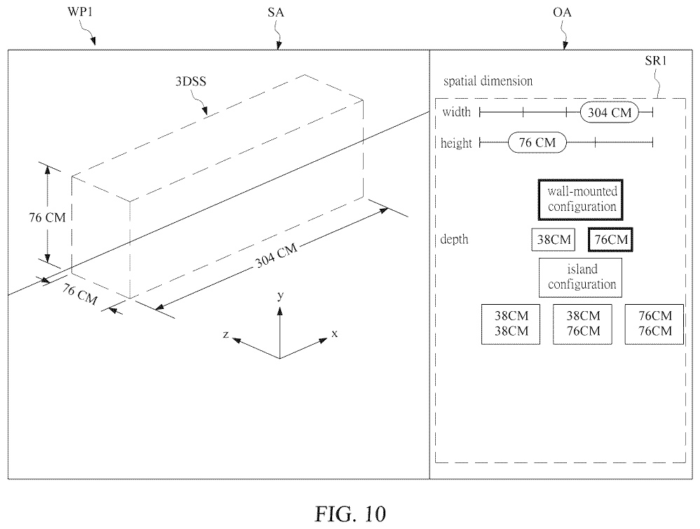

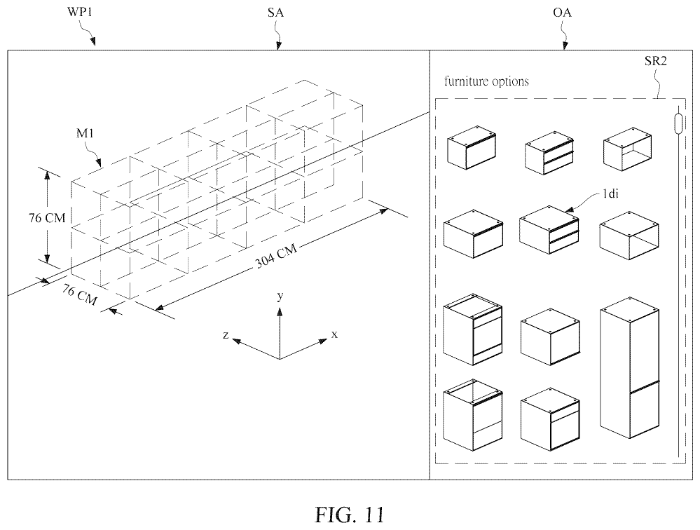

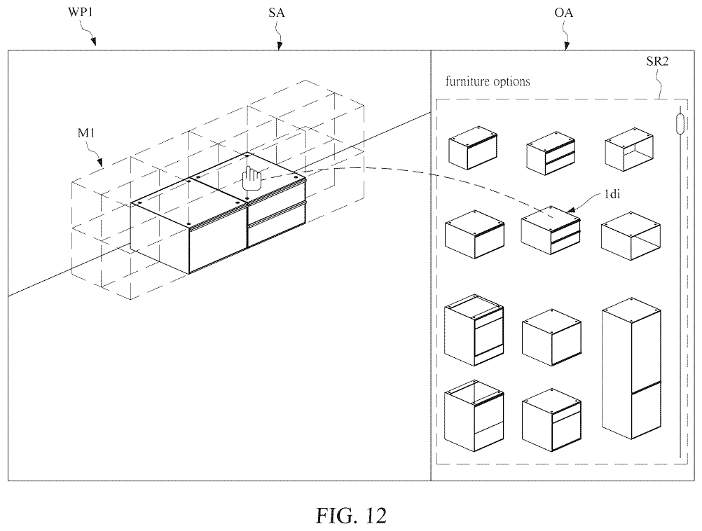

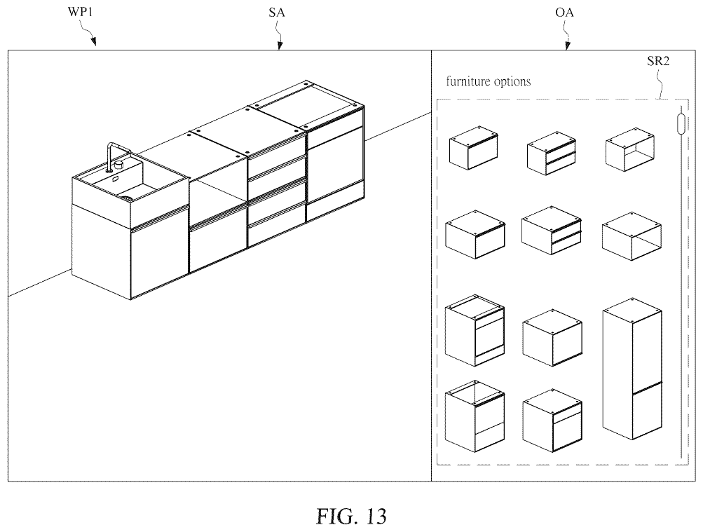

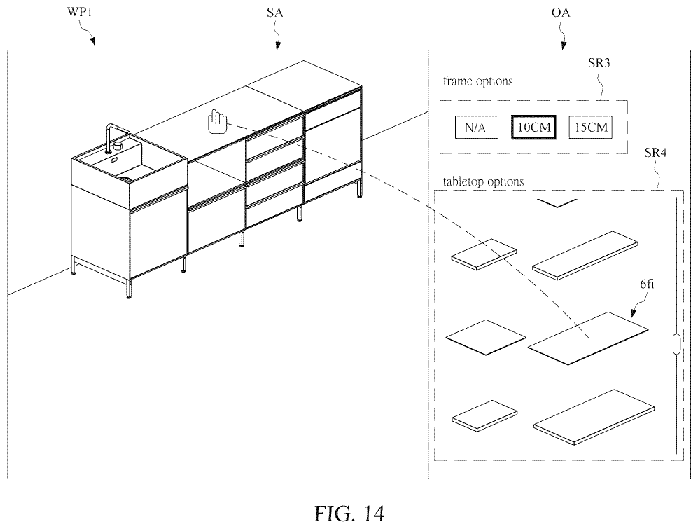

Please proceed to FIG. 10 to FIG. 14 for reference, where FIG. 10 to FIG. 14 are schematic diagrams of corresponding screens illustrating a 3D furniture combination simulation webpage generated based on user operations by an online simulation system for selection and assembly of modular kitchen system furniture according to the present invention.

As shown in FIG. 9 to FIG. 10, the furniture selection interface unit 2022 is electrically connected to the furniture data retrieval unit 2021, and is configured to generate a 3D furniture combination simulation webpage WP1 based on the data retrieved by the furniture data retrieval unit 2021. The 3D furniture combination simulation webpage WP1 includes a furniture option operation area OA and a combined furniture simulation area SA. The furniture option operation area OA is configured to display relevant options for spatial arrangement and furniture selection, while the combined furniture simulation area SA generates a corresponding system furniture simulation screen based on the selection operations performed by users in the furniture option operation area OA.

The 3D furniture combination simulation webpage WP1 generated by the furniture selection interface unit 2022 first displays a spatial dimension selection area SR1 in the furniture option operation area OA. The spatial dimension selection area SR1 includes options related to width, height, and depth for users to select, and the combined furniture simulation area SA displays a modular kitchen system furniture template spatial image 3DSS according to the user's selection of spatial dimensions. The width, height, and depth options generated by the furniture selection interface unit 2022 in the spatial dimension selection area SR1 are based on the unit width UW, the unit height UH, and the unit depth UD of the aforementioned modular kitchen system furniture kit for selective assembly 100, which may be manually input by users or determined by the furniture selection interface unit 2022 by finding the least common multiple based on the data retrieved by the furniture data retrieval unit 2021.

More particularly, the width shown in the spatial dimension selection area SR1 has five dimensions to select from, the height has four dimensions to select from, and the depth has two dimensions to select from in a wall-mounted configuration and three dimensions to select from in an island configuration. In this embodiment, the fourth width option (304 CM), the second height option (76 CM), and the second depth option (76 CM) in the wall-mounted configuration are used as an example.

It should be specifically noted that in this embodiment, the width options are generated based on one to five times the unit width UW, and the unit width UW in this embodiment is, for example, 76 centimeters, therefore the width options displayed in the spatial dimension selection area SR1 include 76 CM, 152 CM, 228 CM, 304 CM, and 380 CM. Similarly, the unit height UH in this embodiment is, for example, 38 centimeters, therefore the height options include 38 CM, 76 CM, 114 CM, and 152 CM, and the unit depth UD in this embodiment is, for example, 38 centimeters, therefore the depth options include 38 CM and 76 CM in the wall-mounted configuration, and 38 CM/38 CM, 38 CM/76 CM, and 76 CM/76 CM in the island configuration. Since the island configuration has two depth dimensions, each single depth option in the island configuration has two depth values.

As stated above, in this embodiment, when the user selects 304 CM width, 76 CM height, and 76 CM depth (wall-mounted) in the spatial dimension selection area SR1, the combined furniture simulation area SA displays, for example, a 76 CM×76 CM×304 CM modular kitchen system furniture template spatial image 3DSS, along with corresponding labels of relevant values. The modular kitchen system furniture template spatial image 3DSS displayed in the combined furniture simulation area SA has its width, height, and depth proportionally scaled to fit the screen size of the combined furniture simulation area SA.

As shown in FIG. 9 to FIG. 11, after the user selects spatial dimensions through the spatial dimension selection area SR1, the furniture selection interface unit 2022 sends the selected dimensions to the template generation unit 2025. The template generation unit 2025 divides the modular kitchen system furniture template spatial image 3DSS into a plurality of unit spatial images M1 (only one is shown) based on the obtained spatial dimensions and the unit width UW, the unit height UH, and the unit depth UD, and displays the unit spatial images M1 in the combined furniture simulation area SA. In this embodiment, the width of the modular kitchen system furniture template spatial image 3DSS in the width direction x is four times the unit width UW, the height in the height direction y is twice the unit height UH, and the depth in the depth direction z is twice the unit depth UD, resulting in that the modular kitchen system furniture template spatial image 3DSS is divided into 4×2×2=16 unit spatial images M1.

Furthermore, the furniture option operation area OA displays a furniture option area SR2. The furniture option area SR2 proportionally displays multiple furniture unit image 1di (only one is shown) based on the data retrieved by the furniture data retrieval unit 2021. For example, the furniture unit image 1di corresponds to the aforementioned storage-type kitchen furniture unit 1a.

As shown in FIG. 9 to FIG. 12, after displaying multiple spliced unit spatial images M1 in the aforementioned combined furniture simulation area SA and the multiple furniture unit images 1di in the furniture option area SR2, the users may select the furniture they want to combine in the 3D furniture combination simulation webpage WP1, and drag their corresponding furniture unit image 1di to the unit spatial image M1 position in the combined furniture simulation area SA, making the furniture unit image 1di occupy the corresponding width, height, and depth and display in the corresponding position in the combined furniture simulation area SA. When a furniture unit image 1di is dragged into the combined furniture simulation area SA, the furniture selection interface unit 2022 splices the corresponding furniture unit image via the furniture unit image splicing unit 2023.

As shown in FIG. 9 to FIG. 13, after the user drags multiple furniture unit images 1di from the furniture option area SR2 into the combined furniture simulation area SA, all unit spatial images M1 may be successively replaced.

As shown in FIG. 9 to FIG. 14, after all unit spatial images M1 in the combined furniture simulation area SA are used, a frame option area SR3 and a tabletop option area SR4 are further displayed in the furniture option operation area OA for users to select. In this embodiment, the frame option area SR3 includes three options, and when the user selects the 10 CM option, the accessory image splicing unit 2024 automatically splices the required frame images to the aforementioned combined system furniture image based on the width and the depth of the aforementioned modular kitchen system furniture template spatial image 3DSS.

For example, since the overall height of the cross-linking frames 4a-4d and the end supporting frames 5a-5d in this embodiment are all 10 centimeters, and may reach up to 15 centimeters after telescopic adjustment. Therefore, the 10 CM in the frame option area SR3 refers to the original height of the cross-linking frames 4a-4d and the end supporting frame5a-5d, while the 15 CM in the frame option area SR3 refers to the extended height of the cross-linking frames 4a-4d and the end supporting frames 5a-5d. Furthermore, since each of the cross-linking frames 4a-4d and the end supporting frames 5a-5d in this embodiment only has one dimension in the depth direction, when the depth of the modular kitchen system furniture template spatial image 3DSS is two times the unit depth UD, the accessory image splicing unit 2024 automatically selects the cross-linking frame 4b and the end supporting frame 5b of twice the unit depth UD.

In summary, the present invention primarily manufactures multiple storage-type kitchen furniture units, multiple appliance-type kitchen furniture units, and multiple sink-type modular kitchen furniture units based on one unit width, one unit height, and one unit depth. Therefore, when the users select the required furniture kit, they may use the furniture kit with proportional relationships in width and depth to make corresponding connections, thereby assembling the modular kitchen system furniture that best meets users' needs.

Through the detailed description of two preferred embodiments, the features and spirit of the present invention are expected to be clearly described, rather than limiting the scope of the present invention to the preferred embodiments disclosed above. On the contrary, the aim is to encompass various modifications and equivalent arrangements within the scope of the patent claims for the present invention.

What is claimed is:

1. A modular kitchen system furniture kit for selective assembly, manufactured according to a unit width, a unit height, and a unit depth and comprising:
a plurality of storage-type kitchen furniture units, each having at least one storage space, and having a first width, a first height, and a first depth, wherein the first width, the first height, and the first depth are integer multiples of the unit width, the unit height, and the unit depth, respectively;
a plurality of appliance-type kitchen furniture units, each being equipped with at least one kitchen appliance and having a second width and a second depth, wherein the second width and the second depth are integer multiples of the unit width and the unit depth, respectively;
a plurality of sink-type modular kitchen furniture units, each being provided with a sink or a sink drainpipe installation space and having a third width and a third depth, wherein the third width and the third depth are integer multiples of the unit width and the unit depth, respectively;
a plurality of cross-linking frames, each having a joining length, wherein the joining length is an integer multiple of the unit depth; and
a plurality of end supporting frames, each having the joining length;
wherein at least two of the storage-type kitchen furniture units, the appliance-type kitchen furniture units, and the sink-type modular kitchen furniture units are selected as at least two selected furniture units to assemble a modular kitchen system furniture, and at least two of the cross-linking frames and the end supporting frames are configured to be assembled onto the modular kitchen system furniture to adjust an elevated height of the modular kitchen system furniture.

2. The modular kitchen system furniture kit for selective assembly of claim 1, wherein each of the cross-linking frames and each of the end supporting frames further comprise a frame base and a pillar body, the frame base is configured to be assembled onto the modular kitchen system furniture and comprises a pillar connection slot, and the pillar body is telescopically inserted and fixed into the pillar connection slot.

3. The modular kitchen system furniture kit for selective assembly of claim 1, further comprising a plurality of top boards, each having a fourth width and a fourth depth, wherein the fourth width and the fourth depth are integer multiples of the unit width and the unit depth, respectively, and at least one of the top boards is configured to cover a top portion of the modular kitchen system furniture except for the sink-type modular kitchen furniture units.

4. The modular kitchen system furniture kit for selective assembly of claim 1, wherein a top portion of each of the storage-type kitchen furniture units, each of the appliance-type kitchen furniture units, each of the cross-linking frames, and each of the end supporting frames comprises at least one first positioning structure, and a bottom portion of each of the storage-type kitchen furniture units and each of the appliance-type kitchen furniture units comprises at least one second positioning structure, such that during assembly, the at least one first positioning structure and the at least one second positioning structure that are vertically adjacent engage for alignment with each other.

5. The modular kitchen system furniture kit for selective assembly of claim 4, wherein the sink-type modular kitchen furniture units comprise at least one sink unit and at least one sink cabinet unit, the at least one sink unit is equipped with the sink, the at least one sink cabinet unit is equipped with the sink drainpipe installation space, the at least one sink unit and the at least one sink cabinet unit are configured to assemble a sink-type kitchen furniture unit, and a bottom portion of each of the sink-type kitchen furniture units comprises at least one second positioning structure.

6. The modular kitchen system furniture kit for selective assembly of claim 4, wherein each of the first positioning structures and each of the second positioning structures are manually rotated and locked using a knob-type bolt.

7. The modular kitchen system furniture kit for selective assembly of claim 1, wherein one of the cross-linking frames is configured to connect at least two selected furniture units that are adjacent along a furniture width direction.

8. The modular kitchen system furniture kit for selective assembly of claim 1, wherein the storage-type kitchen furniture units comprise a single-tier drawer storage cabinet unit, a double-tier drawer storage cabinet unit, or an open storage cabinet unit.

9. The modular kitchen system furniture kit for selective assembly of claim 1, wherein the appliance-type kitchen furniture units comprise an oven-and-induction-cooker combination furniture unit, a dishwasher furniture unit, an induction cooker furniture unit, an oven furniture unit, or a refrigerator furniture unit.

10. The modular kitchen system furniture kit for selective assembly of claim 1, wherein the modular kitchen system furniture is an island-style kitchen system furniture or a wall-mounted kitchen system furniture.

11. The modular kitchen system furniture kit for selective assembly of claim 1, wherein each of the storage-type kitchen furniture units, each of the appliance-type kitchen furniture units, and each of the sink-type modular kitchen furniture units comprise magnets embedded in a side wall thereof to enable mutual magnetic fixation during assembly.

12. An online simulation system for selection and assembly of modular kitchen system furniture having a unit width, a unit height, and a unit depth, the online simulation system comprising:
a data storage module, corresponding to a plurality of storage-type kitchen furniture units, a plurality of appliance-type kitchen furniture units, a plurality of sink-type modular kitchen furniture units, and a plurality of length direction frames, respectively, and storing a plurality of storage-type kitchen furniture unit data, a plurality of appliance-type kitchen furniture unit data, a plurality of sink-type modular kitchen furniture unit data, and a plurality of length direction frame data, respectively, wherein each of the storage-type kitchen furniture unit data comprises a 3D storage-type kitchen furniture unit modeling image, a first width, a first height, and a first depth, each of the appliance-type kitchen furniture unit data comprises a 3D appliance-type kitchen furniture unit modeling image, a second width, a second height, and a second depth, each of the sink-type modular kitchen furniture unit data comprises a 3D sink-type modular kitchen furniture unit modeling image, a third width, and a third depth, and each of the length direction frame data comprises a 3D frame modeling image and a joining length; and
a processing module, communicatively connected to the data storage module, provided with an application installed therein, and connected to an application webpage after executing the application, the application webpage comprising:
a furniture selection interface unit, configured to retrieve the storage-type kitchen furniture unit data, the appliance-type kitchen furniture unit data, the sink-type modular kitchen furniture unit data, and the length direction frame data to allow a user to select at least two from the storage-type kitchen furniture units, the appliance-type kitchen furniture units, and the sink-type modular kitchen furniture units as at least two selected furniture units;
a furniture data retrieval unit, configured to retrieve at least two from the 3D storage-type kitchen furniture unit modeling image, the 3D appliance-type kitchen furniture unit modeling image, and the 3D sink-type modular kitchen furniture unit modeling image as at least two selected 3D furniture unit modeling images according to the at least two selected furniture units;
a furniture unit image splicing unit, configured to be operated by the user to splice the at least two selected 3D furniture unit modeling images into a 3D kitchen system furniture body modeling image; and
an accessory image splicing unit, configured to be operated by the user to splice at least one 3D frame modeling image to the 3D kitchen system furniture body modeling image to form a 3D modular kitchen system furniture modeling image, thereby enabling online simulation of selection and assembly of the modular kitchen system furniture,
wherein the first width, the second width, and the third width are integer multiples of the unit width, the first depth, the second depth, and the third depth are integer multiples of the unit depth, and the first height is an integer multiple of the unit height.

13. The online simulation system for selection and assembly of modular kitchen system furniture of claim 12, wherein the data storage module further stores a plurality of top board data, and each of the top board data comprises a 3D top board modeling image, a fourth width, and a fourth depth.
